(19) United States
(12) Patent Application Publication
(10) Pub. No.: US 2016/0311412 A1
(43) Pub. Date: Oct. 27, 2016

(54) POWER MANAGEMENT METHOD USING BATTERY PACK FOR ELECTRIC VEHICLE

(71) Applicant: Byung Hyouk KANG, Cheonan-si, Chungcheongnam-do (KR)

(72) Inventor: Byung Hyouk KANG, Cheonan-si, Chungcheongnam-do (KR)

(21) Appl. No.: 15/103,564

(22) PCT Filed: Feb. 27, 2014
(86) PCT No.: PCT/KR2014/001612

§ 371 Date: Jun. 10, 2016

(30) Foreign Application Priority Data
Dec. 31, 2013 (KR) 10-2013-0168431

(51) Int. Cl. B60S 5/06; G06Q 50/06; G06Q 20/14; H02J 7/00; G06Q 30/06

(52) U.S. Cl. CPC B60S 5/06; H02J 7/0026; G06Q 30/0645; G06Q 20/14; G06Q 50/06

(57) ABSTRACT

A method includes detaching a discharged battery pack for an electric vehicle, transporting the detached battery pack to a charging/discharging line, charging and storing the discharged battery pack, primarily checking a buffer capacity of the battery pack, classifying the battery pack as a buffer battery pack for replacement if the buffer capacity of the battery pack is found to be equal to or greater than a first buffer capacity, moving the battery pack to an energy storage-dedicated line if the buffer capacity of the battery pack is found to be smaller than the first buffer capacity, secondarily checking the buffer capacity of the battery pack, classifying the battery pack as an ESS-dedicated battery pack, discarding the battery pack if the buffer capacity of the battery pack is found to be smaller than the second buffer capacity, and converting power of the buffer battery pack and the ESS battery pack and sending the converted power.

### BACKGROUND OF THE INVENTION

1. Technical Field

The present invention relates to a power management method using battery packs for an electric vehicle and, more particularly, to a power management method using battery packs for an electric vehicle, wherein necessary power is connected to means, such as a power system line, in association with smart grid device and the power is transmitted to national institutions.

2. Description of the Related Art

As global warming is accelerated, a weather disaster is generated and life is endangered by a serious climate change. Strong control on carbon dioxide is globally spoken with one voice. The auto industry has entered a new phase in accordance with such environmental and social requests. There is a growing interest in an eco-friendly vehicle capable of minimizing the discharge of exhaust gas that is discharged from an internal combustion engine vehicle.

Such an eco-friendly vehicle may be classified into a Hybrid Electric Vehicle (HEV) in which an internal combustion engine and electric power are combined and used, an Electric Vehicle (EV) using only electric power, and a Fuel Cell Electric Vehicle (FCEV) using a fuel cell, depending on their power sources.

In line with a worldwide trend toward a reduction of the discharge of carbon dioxide, in Korea, it is expected that the demand and supply of electric vehicles will be suddenly increased due to the mass production of electric vehicles.

Furthermore, an electric vehicle, such as a Plug-in-Hybrid Electric Vehicle (PHEV), has advantages of low energy consumption and low air pollution. In particular, such an electric vehicle plays an important role in solving environmental pollution and energy reduction problems in the paradigm of a smart grid. As electric vehicles are suddenly used, active research has been carried out on the influence of a load of an electric vehicle on a power grid.

In order to prepare for a power shortage situation, active research is carried out on an Energy Storage System (ESS). The ESS is a system for storing electric power excessively generated from a power plant and supplying the power when power is temporarily short. An ESS is suddenly emerging as a scheme for efficiently utilizing a current electric power generation system.

However, a conventional battery charging system is problematic in that energy using a power source cannot be reused because it is a system for charging a battery for an electric vehicle using only commercial power.

(Patent Document 1) KR2011-0129518 10

(Patent Document 2) KR2013-0101235 10

(Patent Document 3) KR2013-0071923 10

### SUMMARY OF THE INVENTION

Accordingly, the present invention has been made keeping in mind the above problems occurring in the prior art, and an object of the present invention is to provide a power management method using battery packs for an electric vehicle, wherein electric power charged in a battery can be transmitted to a nation and designated institutions in a process of replacing a battery in order to charge a battery for an electric vehicle with electric energy and related profit sources can be created.

In accordance with an aspect of the present invention, a battery pack power management method for replacing a battery pack for an electric vehicle in a charging station for charging or exchanging the battery pack includes a first step of detaching a discharged battery pack of the electric vehicle that has reached the charging station, a second step of transporting the detached discharged battery pack to a charging/discharging line, a third step of charging and storing the discharged battery pack, a fourth step of primarily checking a buffer capacity of the battery pack, a fifth step of classifying the battery pack as a buffer battery pack for replacement if, as a result of the check, the buffer capacity of the battery pack is found to be equal to or greater than a first buffer capacity, a sixth step of moving the battery pack to an energy storage-dedicated line if, as a result of the check, the buffer capacity of the battery pack is found to be smaller than the first buffer capacity, a seventh step of secondarily checking the buffer capacity of the battery pack, an eighth step of classifying the battery pack as an ESS-dedicated battery pack, a ninth step of discarding the battery pack if, as a result of the check, the buffer capacity of the battery pack is found to be smaller than the second buffer capacity by thirdly checking the battery pack, and a tenth step of converting power of the buffer battery pack and the ESS battery pack and sending the converted power.

Furthermore, the tenth step includes steps of comparing an amount of power of the ESS battery pack with an amount of power to be transmitted when a national institution assigns the amount of power to be transmitted that is necessary for an emergent power supply and demand, assigning some of power of the ESS battery pack and the buffer battery pack if the amount of power of the ESS battery pack is insufficient, and converting power of a plurality of the ESS-dedicated battery packs and a plurality of the buffer battery packs that are charged and stored and sending the converted power according to the amount of assigned power.

Furthermore, the lessor of the charging station is a nation or a national-trusted and designated institution, and the lessee of the charging station is a service provider.

Furthermore, the service provider leases a battery and pays a cost for the lease to the nation or the national-trusted and designated institution.

Furthermore, the service provider asks the nation or the national-trusted and designated institution to pay for a cost necessary to manage the charging station.

Furthermore, in the tenth step, a central control apparatus controls power charged in the battery packs and while operating in conjunction with a smart grid device so that the charged power is supplied to an outside in a power consumption peak time zone and the buffer battery pack is charged in other time zones.

Furthermore, the central control apparatus controls power charged in the ESS battery pack included in each charging station so that the charged power is associated with a power system line in case of emergency.

Furthermore, the smart grid device sends information about the power consumption peak time zone and information about an emergent power supply and demand for the nation or the national-trusted and designated institution to the central control apparatus.

Incidentally, the central control apparatus controls the ESS battery packs so that the ESS battery packs are properly distributed over each battery station in proportion to an amount of power that is necessary for each area.

Furthermore, the central control apparatus controls the buffer battery packs so that the buffer battery packs necessary for each area are properly distributed to each battery station.

Furthermore, the central control apparatus reads a car number of the electric vehicle that enters the charging station and notifies a service provider of a number of times that the electric vehicle has entered the charging station so that a user is charged for a lease cost for the buffer battery pack in proportion to the number of times that the electric vehicle has entered the charging station.

### ADVANTAGEOUS EFFECTS

In accordance with the present invention, a plurality of battery packs is charged and stored. Accordingly, there is an advantage in that national energy shortages can be efficiently handled because standby power can be secured and electric energy can be efficiently used by sending the standby power to a nation or a nation-designated institution.

Furthermore, the present invention is a win-win for both a nation and people because a specific profit model can be provided to a service provider and a nation can have a financial return.

Furthermore, energy use efficiency can be maximized because a proper amount of electric energy can be transmitted in a necessary time zone in association with the smart grid device.

### BRIEF DESCRIPTION OF THE DRAWINGS

The accompanying drawings described below show exemplary embodiments of the present invention for the purpose of assisting understanding of the present invention with the detailed description of the embodiments. The drawings should not be interpreted to limit the present inventions in any aspect.

FIG. 1 is a diagram showing that battery packs are classified into a buffer battery pack and an ESS battery pack in a charging station.

FIG. 2 is a flowchart illustrating a power management method using battery packs for an electric vehicle according to the present invention.

FIG. 3 is a flowchart illustrating a method of changing power.

FIG. 4 shows the general construction of the present invention.

### DESCRIPTION OF REFERENCE NUMERALS OF PRINCIPAL ELEMENTS IN THE DRAWINGS

50: smart grid device

100: battery pack

110: buffer battery pack

120: ESS-dedicated battery pack

150: charging/discharging line

200: central control apparatus

S: charging station

### DETAILED DESCRIPTION

Hereinafter, some exemplary embodiments of the present invention are described in detail with reference to the accompanying drawings in order for those skilled in the art to be able to readily practice them. In describing an operational principle relating to the embodiments of the present invention, however, when a detailed description of relevant functions or constructions is deemed to make the subject matter of the present invention unnecessarily obscure, the detailed description will be omitted.

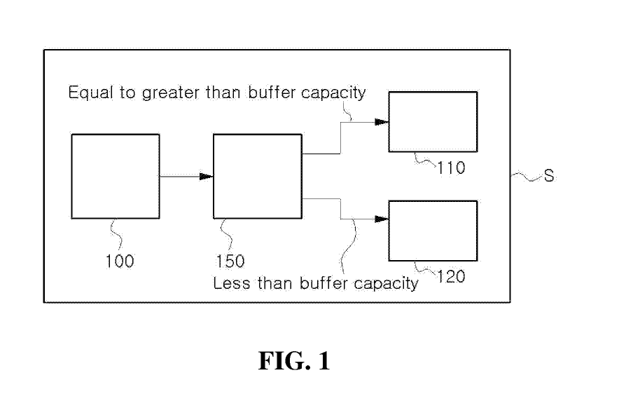

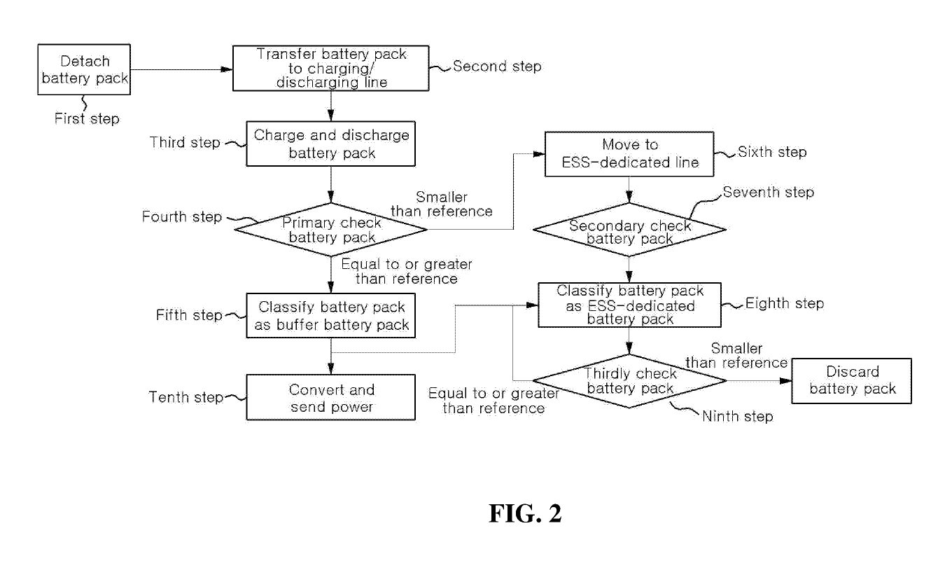

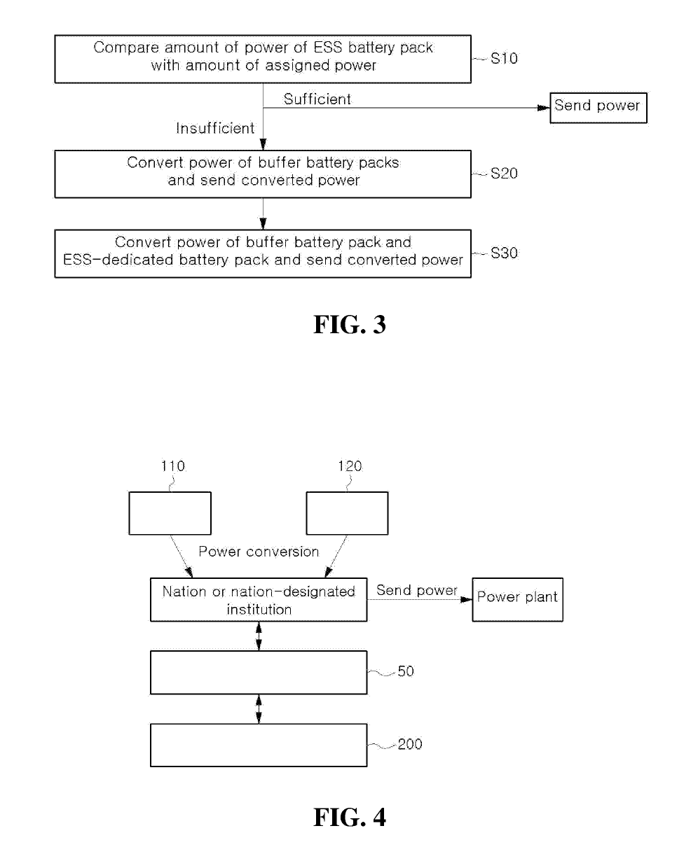

FIG. 1 is a diagram showing that battery packs are classified into a buffer battery pack and an ESS battery pack in a charging station, FIG. 2 is a flowchart illustrating a power management method using battery packs for an electric vehicle according to the present invention, FIG. 3 is a flowchart illustrating a method of changing power, and FIG. 4 shows the general construction of the present invention.

The power management method using battery packs for an electric vehicle according to the present invention includes a battery pack replacement system and an Energy Storage System (ESS). Furthermore, a battery pack installed in an electric vehicle and configured to charge electricity may not be directly purchased by a consumer because the battery pack is very expensive. For this reason, it is hereinafter assumed that a nation rents a battery pack to a consumer at a low price. That is, when purchasing an electric vehicle, a consumer purchases only the vehicle other than a battery pack.

The method according to the present invention is described below with reference to the accompanying drawings. If a battery for an electric vehicle is flat while driving, a driver who owns the electric vehicle reaches a charging station S for charging or exchanging the battery. The charging station S is a system for charging and may be installed an apartment's packing lot, a public parking lot, an existing gas station, and so on.

Here, expenses necessary to install an existing charging station S is shared by a nation or a national-trusted and designated institution and a service provider through a relationship of lease in such a manner that a nation or a national-trusted and designated institution rents the charging station S to a service provider in order to produce a constant profit structure (the ‘service provider’ means a civilian service provider).

Referring first to FIG. 2, the discharged battery pack of the electric vehicle that has reaches the charging station S is detached (first step).

When the electric vehicle enters the charging station S, the discharged battery pack is detached from the electric vehicle and delivered to a charging/discharging line (second step).

The discharged battery pack is charged and stored (third step).

More particularly, a discharged battery pack 100 is charged and stored. The discharged battery pack 100 is fully discharged through a discharging and feeding circuit and then fully charged through a quick charging device.

Next, a buffer capacity of the battery pack is primarily checked (fourth step).

For example, a first buffer capacity of the battery pack 100 is about 70%, and the battery pack 100 is primarily checked based on the first buffer capacity.

If the buffer capacity of the battery pack 100 is equal to or greater than the first buffer capacity, the battery pack 100 is classified as a buffer battery pack for replacement (fifth step). The classified buffer battery pack 110 is managed by the replacement system so that it can replace a discharged battery pack.

If the buffer capacity of the battery pack 100 is smaller than the first buffer capacity, the battery pack 100 is moved to an energy storage-dedicated line and checked (sixth step).

Thereafter, the buffer capacity of the battery pack 100 is secondarily checked (seventh step). Here, a buffer capacity of the battery pack 100 is checked. Accordingly, the amount of power to be transmitted through a power system line, together with a total amount of charging of ESS-dedicated battery packs 120, can be calculated by checking the buffer capacity of each of the ESS-dedicated battery packs 120.

Next, the battery pack 100 is classified as the ESS-dedicated battery pack 120 (eighth step). As described above, the battery pack 100 detached from the electric vehicle is managed.

Next, the battery pack 100 is thirdly checked (ninth step). Here, a lowered buffer capacity of the battery pack 100 is repeatedly checked in real time while the battery pack is used as the ESS-dedicated battery pack 120. The lowered buffer capacity (i.e., a second buffer capacity) is about 10 to 40%, and the ESS-dedicated battery pack 120 is secondarily classified based on the second buffer capacity.

If, as a result of the check, a buffer capacity of the battery pack 100 is smaller than the second buffer capacity, the battery pack 100 is discarded.

Power conversion is performed on power from the buffer battery pack 110 and the plurality of ESS battery packs 120, and the converted power is transmitted through the power system line (tenth step).

It is to be noted that a service provider, that is, a borrower of the charging station S, can be given the money necessary to maintain and manage discarded batteries by asking a nation or a national-trusted and designated institution to pay for a cost for the management of batteries.

Furthermore, the service provider can lease batteries and pay a lease cost to the nation or the national-trusted and designated institution.

As described above, a cost for a battery installed an electric vehicle is very high. Accordingly, a load in purchasing an electric vehicle can be greatly reduced by renting a battery at a low price.

Furthermore, the service provider can ask the nation or the national-trusted and designated institution to pay for a cost for managing a battery pack. That is, the service provider can ask the nation or the national-trusted and designated institution to pay for a maintenance and management cost necessary to manage discarded batteries having a charging rate of about 70% or less.

A method of converting power from the buffer battery pack 110 and the ESS battery pack 120 and sending the converted power is described below.

In the tenth step, a nation and a designated institution determines the amount of power that may be supplied by ESS batteries that are distributed over areas in case of emergency through a smart grid device 50.

The smart grid device 50 is described in brief below with reference to FIG. 3.

The smart grid device 50 is the next-generation power network using information communication technology in a power network. The smart grid device 50 controls electric power through bi-directional digital communication between a supplier and a consumer by overlaying an existing power grid, including power use information for consumers, with a network measurement system, thereby reducing energy and improving reliability and transparency.

If a national institution requests the supply of power, the amount of power to be transmitted necessary for an emergent power supply and demand is assigned. The amount of power of the ESS battery pack 120 is compared with the amount of power to be transmitted at step S 10.

If, as a result of the comparison, the amount of power to be transmitted from the amount of power charged in the buffer battery pack 110 is greater than a total amount of power of all the ESS-dedicated battery packs, some of the buffer battery packs 110 are provided. If a total amount of power of all the ESS battery packs 120 is insufficient, some of the ESS battery packs 120 and the buffer battery pack 110 are assigned at step S20.

Thereafter, power from the plurality of ESS-dedicated battery packs 120 and the plurality of buffer battery packs 110 charged and stored according to the amount of assigned power is converted and transmitted at step S30.

Here, power from the plurality of ESS-dedicated battery packs 120 and the plurality of buffer battery packs 110 is converted and transmitted through the power system line.

That is, a central control apparatus 200 connects the ESS-dedicated battery packs 120 and the buffer battery packs 110 in series and in parallel according to the amount of assigned power and supplies power to the power system line through a power conversion apparatus. As described above, power from all the ESS-dedicated battery packs 120 and power from some of or all the buffer battery packs 110 according to the amount of assigned power are controlled so that they are transmitted. Furthermore, in case of emergency, power charged in the ESS battery packs 120 included in each of the charging stations S is connected to the power system line and supplied thereto.

The central control apparatus 200, that is, one of the elements of the present invention, is described below.

At step S10, the central control apparatus 200 controls power charged in the battery packs 110 and 120 while operating in conjunction with the smart grid device 50 so that the power is supplied to the outside in a power consumption peak time zone and the battery packs 110 and 120 are charged.

Accordingly, when power consumption is small, the battery packs 110 and 120 are charged with power. The power charged in the battery packs 110 and 120 is supplied to the outside in a power consumption peak time zone in which the transmission of power is requested by the smart grid device 50, thereby being capable of improving use efficiency of power. In other time zones, the buffer battery packs 110 are charged with power.

It is to be noted that the aforementioned power supply method is not performed regularly. In other words, the person in charge may flexibly manage the charging of battery packs manually although it is a power consumption peak time zone.

Furthermore, in case of emergency, the central control apparatus 200 may control power charged in only the ESS battery pack 120 within each charging station S so that the power is converted and used. If it is difficult to use the buffer battery pack 110 when it is necessary to supply power in case of emergency, power may be supplied using only the stored ESS battery pack 120.

Referring to FIG. 4, the smart grid device 50 sends information about a power consumption peak time zone and information about an emergent power supply and demand for a nation or a national-trusted and designated institution to the central control apparatus 200. In this case, there is an advantage in that a change of weather or a change of a power consumption situation can be actively handled in the initial stages. In addition, the battery packs 110 and 120 can be usefully used because pieces of information are exchanged in real time through the smart grid device 50.

That is, the central control apparatus 200 controls the ESS battery packs 120 so that the ESS battery packs 120 can be properly distributed over the battery station (not shown) of each area in proportion to the amount of power that is necessary for each area. Optimum ESS battery packs 120 are provided to each battery station so that power can be transmitted in case of emergency.

Furthermore, the central control apparatus 200 can control the ESS battery packs 120 depending on the characteristics of each area so that the ESS battery packs 120 are properly placed in each area in proportion to the amount of power consumed by the area. For example, in the industry area, such as a factory area, the ESS battery pack 120 is in greater demand than the buffer battery pack 110. Accordingly, the ESS battery pack 120 is disposed in a charging station S that is placed in a factory area.

Furthermore, the central control apparatus 200 controls the buffer battery packs 110 so that the buffer battery packs 110 necessary for each area can be properly distributed over battery stations. For example, the charging of a battery pack for an electric vehicle will be in great demand in a big city, such as a metropolitan city, and the charging of a battery pack for an electric vehicle will not be in great demand in a small city. Accordingly, the central control apparatus 200 controls the buffer battery packs 110 so that the buffer battery packs 110 can be properly distributed in proportion to the demand.

The central control apparatus 200 reads a car number of an electric vehicle that enters the charging station S and notifies a service provider of the number of times that the electric vehicle has entered the charging station S. Accordingly, a user can be charged for a lease cost for the buffer battery pack 110 in proportion to the number of times that a corresponding electric vehicle has entered the charging station S. Accordingly, a service provider can ask a person who uses a buffer battery pack a lot to pay for a high cost and can ask a person who uses a buffer battery pack little to pay for a low cost.

Accordingly, the present invention is advantageous in that power can be smoothly supplied through the power conversion apparatus and energy can be effectively used and resources can be reduced because power can be smoothly supplied, distributed, and reproduced in association with the smart grid device 50.

As described above, those skilled in the art to which the present invention pertains will understand that the present invention may be implemented in various detailed forms without changing the technical spirit or essential characteristics of the present invention. It will be understood that the above-described embodiments are illustrative and not limitative from all aspects.

Furthermore, the scope of the present invention is defined by the appended claims rather than the detailed description, and the present invention should be construed as covering all modifications or variations derived from the meaning and scope of the appended claims and their equivalents.

What is claimed is:

1. A battery pack power management method for replacing a battery pack for an electric vehicle in a charging station S for charging or exchanging the battery pack, the method comprising:
a first step of detaching a discharged battery pack for the electric vehicle that has reached the charging station S;
a second step of transporting the detached discharged battery pack to a charging/discharging line 150;
a third step of charging and storing the discharged battery pack;
a fourth step of primarily checking a buffer capacity of the battery pack;
a fifth step of classifying the battery pack as a buffer battery pack 110 for replacement if, as a result of the check, the buffer capacity of the battery pack is found to be equal to or greater than a first buffer capacity;
a sixth step of moving the battery pack to an energy storage-dedicated line if, as a result of the check, the buffer capacity of the battery pack is found to be smaller than the first buffer capacity;
a seventh step of secondarily checking the buffer capacity of the battery pack;
an eighth step of classifying the battery pack as an ESS-dedicated battery pack 120;
a ninth step of discarding the battery pack if, as a result of the check, the buffer capacity of the battery pack is found to be smaller than the second buffer capacity by thirdly checking the battery pack; and
a tenth step of converting power of the buffer battery pack 110 and the ESS battery pack 120 and sending the converted power.

2. The battery pack power management method of claim 1, wherein the tenth step comprises:
a tenth step S10 of comparing an amount of power of the ESS battery pack 120 with an amount of power to be transmitted when a national institution assigns the amount of power to be transmitted that is necessary for an emergent power supply and demand;
a twentieth step S20 of assigning some of power of the ESS battery pack 120 and the buffer battery pack 110 if the amount of power of the ESS battery pack 120 is insufficient; and
a thirtieth step S30 of converting power of a plurality of the ESS-dedicated battery packs 120 and a plurality of the buffer battery packs 110 that are charged and stored and sending the converted power according to the amount of assigned power.

3. The battery pack power management method of claim 1, wherein a lessor of the charging station S is a nation or a national-trusted and designated institution, and a lessee of the charging station S is a service provider.

4. The battery pack power management method of claim 3, wherein the service provider leases a battery and pays a cost for the lease to the nation or the national-trusted and designated institution.

5. The battery pack power management method of claim 3, wherein the service provider asks the nation or the national-trusted and designated institution to pay for a cost necessary to manage the charging station S.

6. The battery pack power management method of claim 1, wherein in the tenth step, a central control apparatus 200 controls power charged in the battery packs 110 and 120 while operating in conjunction with a smart grid device 50 so that the charged power is supplied to an outside in a power consumption peak time zone and the buffer battery pack 110 is charged in other time zones.

7. The battery pack power management method of claim 6, wherein the central control apparatus 200 controls power charged in the ESS battery pack 120 included in each charging station S so that the charged power is associated with a power system line in case of emergency.

8. The battery pack power management method of claim 6, wherein the smart grid device 50 sends information about the power consumption peak time zone and information about an emergent power supply and demand for the nation or the national-trusted and designated institution to the central control apparatus 200.

9. The battery pack power management method of claim 6, wherein the central control apparatus 200 controls the ESS battery packs 120 so that the ESS battery packs 120 are properly distributed over each battery station in proportion to an amount of power that is necessary for each area.

10. The battery pack power management method of claim 6, wherein the central control apparatus 200 controls the buffer battery packs 110 so that the buffer battery packs 110 necessary for each area are properly distributed to each battery station.

11. The battery pack power management method of claim 6, wherein the central control apparatus 200 reads a car number of the electric vehicle that enters the charging station S and notifies a service provider of a number of times that the electric vehicle has entered the charging station S so that a user is charged for a lease cost for the buffer battery pack 110 in proportion to the number of times that the electric vehicle has entered the charging station S.
